(19) United States
(12) Patent Application Publication
(10) Pub. No.: US 2017/0010367 A1
(43) Pub. Date: Jan. 12, 2017

(54) DEVICE FOR VIEWING PHOTONICS RADIATION, SUITABLE FOR WORKING IN A RADIOACTIVE ENVIRONMENT, AND CAMERA USING SUCH A DEVICE

(71) Applicant: ERMES, Saclay (FR)

(72) Inventor: Guillaume DEJAVDAN, MONTFORT L'AMAURY (FR)

(21) Appl. No.: 15/113,145

(22) PCT Filed: Jan. 22, 2015
(86) PCT No.: PCT/FR2015/050156

§ 371 Date: Jul. 21, 2016

(30) Foreign Application Priority Data
Jan. 29, 2014 (FR) 14 00232

(51) Int. Cl. G01T 1/24; G01T 7/00

(52) U.S. Cl. CPC G01T 1/244; G01T 7/00

(57) ABSTRACT

A device for capturing an image in a radioactive environment, includes: image detectors (11, 12, 13); an area (16) for capturing the images; a heating area (17) for regenerating the detectors; an area (18) for cooling the detectors; and a support (14) for moving the detectors successively into each area. A camera including such a device and especially a camera for creating an image of a gamma-ray source in a nuclear environment is also described.

The invention applies to the field of devices enabling images to be taken in a radioactive environment, in particular of a gamma source.

For maintenance, inspection or monitoring operations, for example in a nuclear power station, a nuclear waste treatment plant, a decontamination site or when dismantling a nuclear site, observations may be necessary, particularly in the visible wavelength region, even on sites or premises subjected to a radioactive environment. Cameras resistant to high radiation levels are known and use “tube” technology. However, such cameras are voluminous, heavy and expensive, and furthermore have the disadvantage of only generating black and white images, said images not being digital. Current digital cameras are sensitive to radioactive environments; their detector in particular becomes quickly saturated, or destroyed too quickly, to allow such a camera to be used in such an environment.

More exceptionally, in the event of a nuclear accident, a mapping must be produced in order to take faster and more precise action at the source of an emission or contamination. Gamma cameras are currently used remotely, due to their sensitivity to radioactive environments, for example from a helicopter flying over a radioactive area. However, in order to map the sources of radiation, a camera must sometimes penetrate an irradiated enclosure.

The purpose of the invention is to propose one or multiple devices capable of taking still or moving images in a radioactive environment, in particular for determining the position of a radioactive source, for example a gamma source. Preferably, such devices must be able to tolerate cumulated doses of between 1 kiloGray and 1 megaGray and rates up to several kiloGray.h⁻¹, sometimes even several tens of kiloGray.h⁻¹.

In a radioactive environment, the image obtained is gradually impeded by dots, corresponding to successive impacts of gamma particles on the detector, thus giving the image a snowy appearance. Due to high remanence, the image gradually becomes filled with dots until it is saturated, i.e. substantially uniformly coloured, such that this image can no longer be used.

In the case of observing visible radiation, the gamma radiation emitted by the radioactive environment produces the same snow-like effect that slowly covers the image of the visible radiation until this image becomes unusable.

Multiple solutions have appeared, each of which can be taken alone or in combination with another. Firstly, certain electronic components have appeared, in particular image detectors capable of regeneration after having been subjected to radiation. Such regeneration can be obtained via heating.

According to a first object of the invention, a device for capturing an image, or multiple images, that are still or video, in a radioactive environment comprises at least two image detectors, and means for alternatively regenerating each detector, preferably via heating.

The detection means can include a support for the detectors, the support being capable of moving between a position wherein a first detector is in a capture area for the image and a second detector is in a regeneration area, and, a position wherein the second detector is in a capture area and the first detector is in a regeneration area. The regeneration area advantageously comprises a heating area for the detectors and an area for cooling after heating.

Preferably, the device comprises three image detectors, such that a first detector is in the capture area, while a second detector, previously in the capture area, is in the heating area, while a third detector, previously heated, is in the cooling area.

In order to control the temperature of the components, in particular the image detectors, during heating, a temperature sensor is used, such as a platinum sensor, for example of the type PT100™ or PT1000™, supplied by Prosensor™; such a temperature sensor is advantageously bonded to the component to be monitored, preferably with a high-temperature adhesive, for example EPOTEK H77™ adhesive, supplied by Epotek™. In order to prevent the welds of the components from melting, a high-temperature solder wire is preferably used, for example DHMP 500G REEL™ solder wire supplied by Multicore™.

For a device according to the invention, a video image detector using CMOS technology is preferably used. Such an image detector normally designed for capturing images in the visible range, can also be used to capture gamma radiation. Indeed, gamma rays produce the aforementioned snow-like effect on the detector; this in particular provides a workable image of this gamma radiation, with sufficient approximation for locating one or multiple gamma radiation sources, without using, for example scintillation cameras, which are not resistant enough in a highly radioactive environment.

Means for controlling the regeneration cycle, in particular the heating cycle, and/or means for processing the data collected by the detector, in particular to render an image from said data, are advantageously installed remotely, outside of any highly irradiated area.

According to another object, the invention relates to a camera comprising such a capture device according to the invention, in particular a camera designed to take images of visible radiation, while protecting the detectors from the radioactive environment.

Preferably, this camera comprises a body defining two compartments, one first compartment of which contains a lens and a mirror, and the second compartment comprises the capture device, whereby the mirror is positioned to laterally reflect radiation transmitted by the lens to a capture area of said device. Advantageously, the body forms a shield designed to protect the capture device from non-observed radiation, in particular from radiation outside of the wavelengths visible to man, in particular from gamma radiation, which would saturate the detectors too quickly.

A camera can further comprise a collimator. The collimator can be a plate made from a metal with a high atomic number, preferably lead or tungsten, said plate being drilled with holes, preferably cylindrical or conical, parallel to a desired observation axis.

The collimator can also be used with a camera only using a single detector and/or a device according to the invention, positioned directly behind the lens.

Different and alternative embodiments will be described hereafter, as non limitating examples, with reference to the appended figures, wherein:

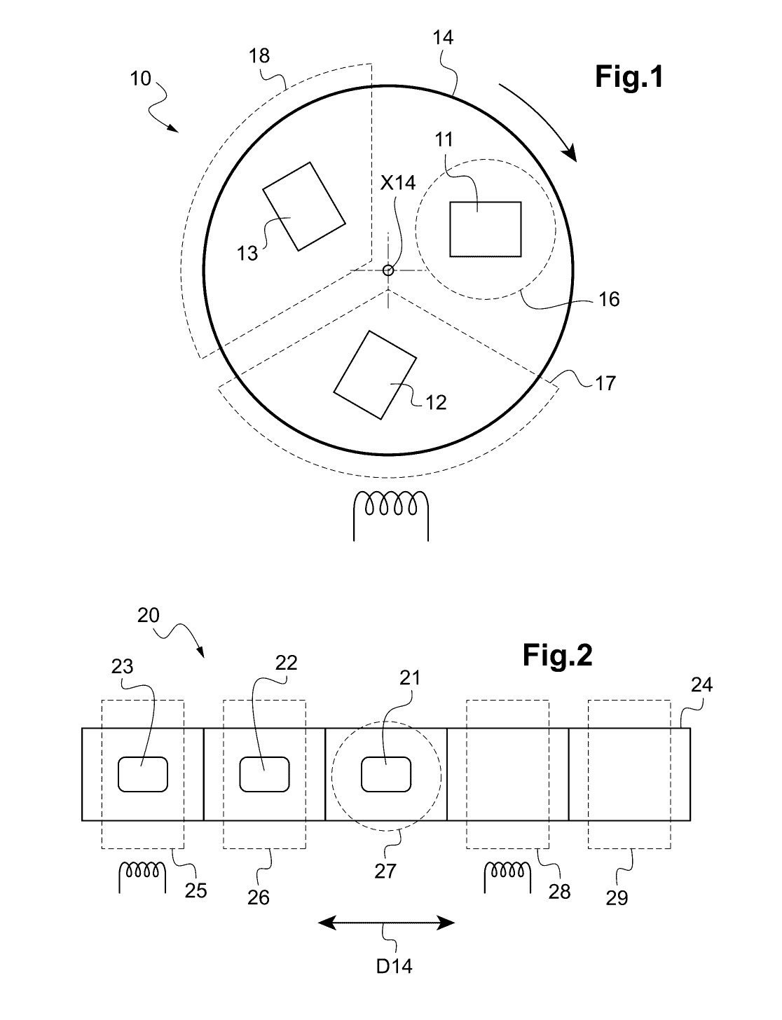

FIG. 1 is a schematic illustration of a first device according to the invention, using three detectors mounted on a rotational support;

FIG. 2 is a schematic illustration of a second device according to the invention, using three detectors mounted on a translational support;

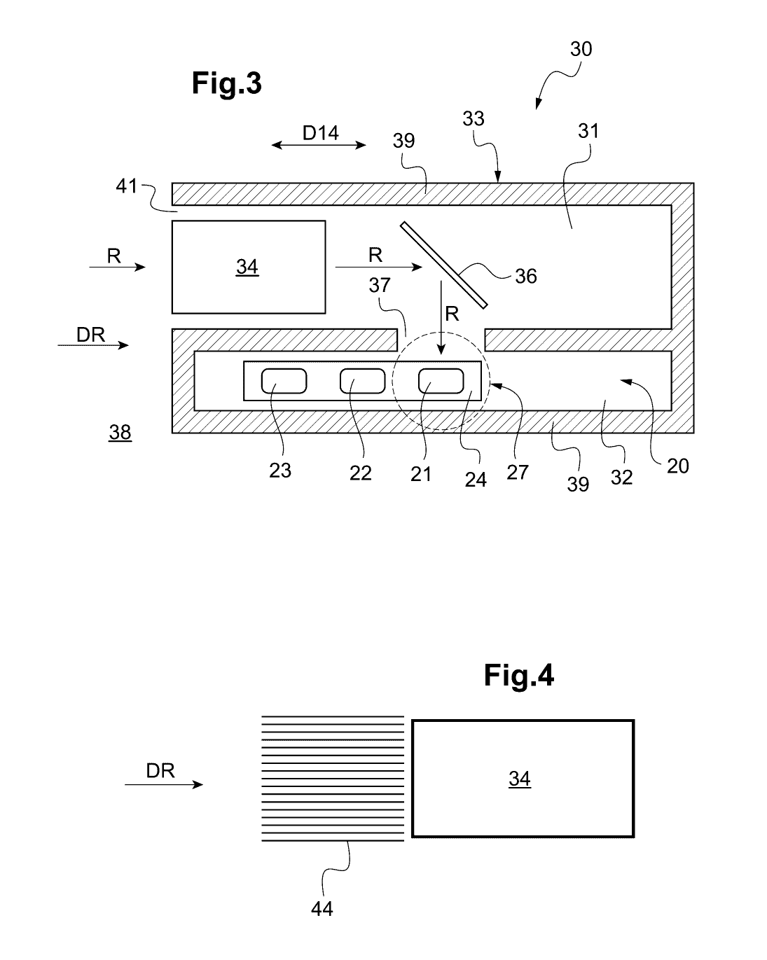

FIG. 3 is a schematic illustration of a camera according to the invention, using the device in FIG. 2; and,

FIG. 4 is a schematic illustration of a collimator that can be used in combination with a device illustrated in FIG. 1 or 2.

FIG. 1 illustrates a device 10 for capturing images, suitable for use in a camera subjected to a radioactive environment. This device comprises three detectors 11, 12, 13 mounted on a support 14. In this example, the support is a disc mounted such that it rotates about a central axis X14 perpendicular to the disc.

The device further comprises three areas 16, 17, 18, illustrated via dotted lines in FIG. 1, including:
a capture area 16, wherein a first detector 11, from the three detectors, is exposed to radiation, an image of which must be taken;
a heating area 17, wherein a second detector 12, previously exposed, is heated for regeneration; and
a cooling area 18, wherein the third detector 13 is cooled after having been heated.

Positioned in such a manner, each detector successively moves from one area to another via the successive rotations of the disc 14. Therefore, a detector is exposed in the capture area, then after a first rotation, it is regenerated in the heating area, while the following detector is exposed, then it is cooled in the cooling area, while the third detector is in turn exposed.

FIG. 2 illustrates another embodiment for a capture device according to the invention. In this example, the device 20 also comprises three detectors 21, 22, 23 and a support in the shape of a strip 24. The three detectors are aligned with each other on the strip 24. The device further comprises five areas which are, as shown in FIG. 2, from left to right:
a first heating area 25;
a first cooling area 26;
a capture area 27;
a second heating area 28; and,
a second cooling area 29.

In FIG. 2, the strip 24 is positioned such that a first detector 21 is in the capture area 27, a second detector 22 is in the first cooling area 26, and the third detector 23 is in the first heating area 25.

The strip 24 is mounted such that it slides within five areas 25-29 so that when the strip is moved parallel to a direction D14, from left to right, from area to area:
the first detector 21 moves from the capture area 27 to the second heating area 28, then, from the second heating area to the second cooling area; while simultaneously,
the second detector 22 moves from the first cooling area 26 to the capture area, then, from the capture area 27 to the second heating area 28; while simultaneously,
the third detector 23 moves from the first heating area 25 to the first cooling area, then, from the first cooling area 26 to the capture area 27.

Then, a translation parallel to direction D14, towards the left, brings the strip 24 back to its initial position shown in FIG. 2, such that a full cycle is completed. Each detector 21-23 can therefore take on, during a full cycle, a capture position, followed by a heating position then a cooling position, as for the device in FIG. 1, with the same advantages.

FIG. 3 illustrates the use of the device shown in FIG. 2, in a camera 30 according to the invention, designed to capture an image under visible light in a radioactive environment.

In the example illustrated, the camera 30 comprises a body 33 forming two compartments 31, 32; the compartments extending longitudinally, substantially parallel to the direction of movement D14 of the strip 24. A first compartment 31, from the two housings 31, 32, contains optical means 34, 36 of the camera 30. The second compartment 32 contains the capture device 20 shown in FIG. 2.

The compartments 31, 32 are substantially isolated from the environment 38 external to the camera 30 via walls 39 of the body 33 of the camera; furthermore, the compartments 31, 32 are substantially isolated by additional walls 39 of the body, except where the compartments communicate with each other via a lateral window 37 positioned opposite the capture area 27 of the capture device 20. The window 37 can be a simple aperture or include a wall that is transparent to radiation.

The optical means comprise a lens 34 and a mirror 36. The first compartment 31 is substantially isolated from the environment 38 external to the camera 30, via walls 39 of the body 33 of the camera 30, except through an aperture 41 occupied by the lens 34; the aperture 41 is formed at one longitudinal end of the body 33. The mirror 36 is positioned such that it reflects the radiation originating from the lens towards the aperture 37. In the example illustrated, the mirror 36 is positioned such that it reflects the observed radiation R at 90 degrees to its initial direction DR.

In the position shown in FIG. 3, the lens 34 is directed substantially towards a light source, such that:
a portion R of these rays longitudinally penetrates the camera, along the direction DR, through the lens 34, then,
the rays R are laterally reflected by the mirror 36; then,
the rays R penetrate, passing through to the window 37, the capture area 27 of the capture device 20; and,
the rays R hit the detector, in this case the first detector 21, which is located in the capture area 27.

Such a camera can in particular be used to separate radiation having visible wavelengths, an image of which must be captured, from the radioactive radiation; the visible radiation being reflected by the mirror, the radioactive radiation, in particular gamma rays, passing through the mirror without being reflected.

In the example illustrated, the walls 39 of the body 33 comprise a lead shield measuring about 3 cm. The embedded electronics in the camera 30, not shown in the figures, are also protected by the walls 39. Therefore, these walls and the use of the mirror 36 protect in particular the detectors 21-23 from the noise formed by gamma-type radiation, which is not involved in the observation and which saturates the detectors too quickly. Such a protection considerably increases the time during which a detector can be used for capturing before being regenerated.

In the example illustrated in FIG. 4, a collimator 54 is mounted on the lens 44, on the side external to the camera. This collimator is a plate made from lead, tungsten or another metal with a high atomic number, therefore substantially impervious to gamma rays. This plate is drilled with cylindrical or conical holes, parallel to a desired observation axis DR. The collimator 54 is used to filter the photons, in particular the gamma photons emitted by the source observed, such that only the photons originating from an area situated in the axis of the collimator 44 can reach the lens 34.

Of course, the invention is not limited to the aforementioned examples of embodiment.

Two cameras according to the invention can therefore be used to obtain a three-dimensional still or video image.

A camera according to the invention can further use the first embodiment for a capture device, i.e. rotational, rather than the translational device illustrated in FIG. 3. A different support and movement mode can also be used.

Depending on the relative optimum times for exposure, heating and cooling, more than three detectors may be advantageously used, such that the same detector can spend more or less time in one zone compared to another. The use of two detectors may also suffice, whereby one is exposed while the second is heated then cooled at the same time.

The shielding walls of a camera according to the invention can be made from another metal or from any other material suitable for isolating from a radioactive environment.

A device according to the invention can be used in all systems requiring an image to be taken under radioactive radiation. Such a system can in particular include a camera, designed to capture visible radiation, as previously illustrated, and/or gamma radiation.

1. Device (10; 20) for capturing an image in a radioactive environment, which comprises at least two image detectors (11-13; 21-23), and regeneration means (17; 25,28) for alternately regenerating each detector, preferably by heating.

2. Device according to claim 1, further comprising:
an area (16; 27) for capturing the image; and,
at least one area (17, 18; 25, 26, 28, 29) for regenerating said detectors;
the capture means further comprising a support (14; 24) for the detectors, said support being capable of moving between:
a position wherein a first (11; 21) detector is in said capture area and a second detector (12, 13; 22, 23) is in the regeneration area; and,
a position wherein the second detector is in a capture area and the first detector is in a regeneration area.

3. Device according to claim 2, wherein the regeneration area advantageously comprises an area (17; 25, 29) for heating the detectors and an area (18; 26, 29) for cooling the latter after heating.

4. Device according to claim 2, wherein the support is a rotational support (14).

5. Device according to claim 2, wherein the support is a translational support (24).

6. Device according to claim 2, wherein the device comprises three detectors, such that a first detector is in the capture area, while a second detector, previously in the capture area, is in the heating area, while a third detector, previously heated, is in the cooling area.

7. Device according to claim 5, wherein the device comprises, in the following order:
a first heating area (25);
a first cooling area (26);
a capture area (27);
a second heating area (28); and,
a second cooling area (29).

8. Device according to claim 1, wherein the device is suitable for capturing an image of gamma radiation.

9. Camera (30), which comprises a capture device (10, 20) according to claim 1.

10. Camera according to claim 9, which comprises a body (33) defining two compartments (31, 32), one first compartment (31) of which contains a lens (34) and a mirror (36), and the second compartment comprises the capture device (20), whereby the mirror is positioned to laterally reflect radiation (R) transmitted by the lens to a capture area (27) of said device (20).

11. Camera according to claim 10, wherein the body forms a shield (39) designed to protect the capture device from radioactive radiation.

12. Camera according to claim 9, further comprising a collimator (44).

13. Camera according to claim 12, wherein the collimator is a plate made from a metal with a high atomic number, preferably lead or tungsten, said plate being drilled with holes, preferably cylindrical or conical, parallel to a desired observation axis (DR).

14. Device according to claim 3, wherein the support is a rotational support (14).

15. Device according to claim 3, wherein the support is a translational support (24).

16. Device according to claim 3, wherein the device comprises three detectors, such that a first detector is in the capture area, while a second detector, previously in the capture area, is in the heating area, while a third detector, previously heated, is in the cooling area.

17. Device according to claim 4, wherein the device comprises three detectors, such that a first detector is in the capture area, while a second detector, previously in the capture area, is in the heating area, while a third detector, previously heated, is in the cooling area.

18. Device according to claim 5, wherein the device comprises three detectors, such that a first detector is in the capture area, while a second detector, previously in the capture area, is in the heating area, while a third detector, previously heated, is in the cooling area.

19. Device according to claim 6, wherein the device comprises, in the following order:
a first heating area (25);
a first cooling area (26);
a capture area (27);
a second heating area (28); and,
a second cooling area (29).
